(19) United States
(12) Patent Application Publication
(10) Pub. No.: US 2004/0088268 A1
(43) Pub. Date: May 6, 2004

(54) Mail piece processing with weight ranges

(76) Inventor: Robert C. Mayes, Boise, ID (US)

Correspondence Address: HEWLETT-PACKARD COMPANY, Intellectual Property Administration, P. O. Box 272400, Fort Collins, CO, 80527-2400, US

(21) Appl. No.: 10/284,940

(22) Filed: Oct. 31, 2002

(51) Int. Cl. G06F 17/00

(52) U.S. Cl. 705/407

(57) ABSTRACT

A mail piece processing system includes a weight system, postage system, and control system. The weight system weighs and transfers first mail pieces, and in response to a stop weigh instruction, transfers second mail pieces without weighing them. The postage system applies postage to the mail pieces in response to postage instructions. The control system transfers the postage instructions where the postage corresponds to a weight range. The control system determines if the first mail pieces are within the weight range, and if so, transfers the stop weigh instruction.

### BACKGROUND OF THE INVENTION

1. Field of the Invention

The invention is related to the field of mail processing, and in particular, to using a weight range to avoid individually weighing each mail piece when applying postage.

2. Statement of the Problem

Many businesses use delivery services to deliver large numbers of mail pieces. For example, a business may use the postal service to deliver thousands of packages containing a sample product. The delivery services require the business to apply sufficient postage to each mail piece before delivery will be provided. These delivery services have various weight ranges that have corresponding postage rates. For each mail piece, the business selects a weight range based on the weight of the mail piece and then applies the postage for the weight range to the mail piece. The application of postage to the mail piece can be accomplished in various ways including: printing postage indicia directly on the mail piece, printing postage indicia on an item that can be affixed to the mail piece, or charging the postage for the mail piece to a postage account without printing or affixing postage indicia to the mail piece. Automated processing systems are available to perform these tasks.

A typical automated processing system includes a conveyor that transfers the mail pieces through the system. The conveyor contains an in-line scale that individually weighs each mail piece. Based on the individual weights, the system selects weight ranges for the mail pieces and applies postage for the weight ranges to the mail pieces. Unfortunately, the conveyor must be paused for the in-line scale to weigh each mail piece. For a job including thousands of mail pieces, this pause adds significant time to the overall process and adds wear to the conveyor components. More efficient mail piece processing systems and methods are needed.

### SUMMARY OF THE SOLUTION

The invention helps solve the above problems with systems, methods, and products to efficiently apply postage to mail pieces. Advantageously, the systems and methods can eliminate the time-consuming weighing process for a large portion of the mail pieces. Examples of the invention include mail piece processing systems, operational methods, and computer program products.

An exemplary mail piece processing system includes a weight system, postage system, and control system. The weight system is configured to weigh and transfer first mail pieces, and in response to a stop weigh instruction, to transfer second mail pieces without weighing the second mail pieces. The postage system is configured to apply postage that corresponds to a weight range to the mail pieces in response to postage instructions. The control system is configured to transfer the postage instructions, determine if the first mail pieces are within the weight range, and if the first mail pieces are within the weight range, to transfer the stop weigh instruction.

An exemplary method of operating a mail piece processing system comprises: weighing first mail pieces; determining if the first mail pieces are within a weight range; if the first mail pieces are within the weight range, applying postage that corresponds to the weight range to the first mail pieces; and if the first mail pieces are within the weight range, applying the postage to second mail pieces without weighing the second mail pieces.

### DESCRIPTION OF THE DRAWINGS

The same reference number represents the same element on all drawings.

FIG. 1 illustrates the configuration of a mail piece processing system according to one embodiment of the invention.

FIG. 2 illustrates the operation of a mail piece processing system according to one embodiment of the invention.

FIG. 3 illustrates a control system for a mail piece processing system according to one embodiment of the invention.

### DETAILED DESCRIPTION OF THE INVENTION

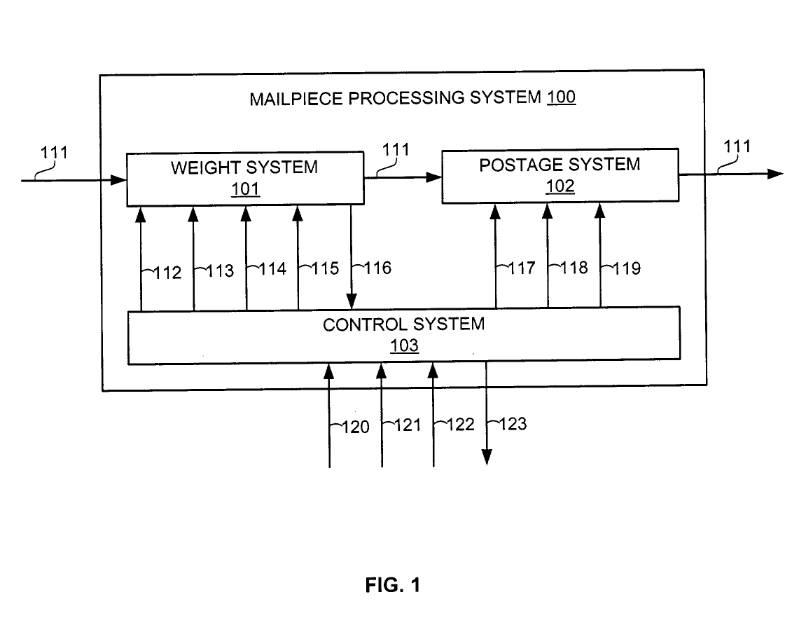

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates mail piece processing system 100 in an example of the invention. Mail piece processing system 100 comprises weight system 101, postage system 102, and control system 103. Mail piece processing system 100 receives mail pieces 111, applies postage to mail pieces 111, and transfers mail pieces 111 with the applied postage. Mail piece processing system 100 is configured for automatic operation and has a conveyor or some other mechanism for transferring mail pieces 111 through system 100. Mail piece processing system 100 may include additional systems and features that are not shown for clarity. For example, a sorting system to sort mail pieces 101 by service class or destination may be placed before weight system 101.

In the context of the invention, the term “mail piece” means an item that will be delivered by the United States Postal Service, or a similar delivery service such as FedEx, if the postage applied to the item is sufficient. Postage refers generally to the shipping fee required by the delivery service to deliver a mail piece. Mail pieces 111 fall into various weight ranges where each weight range has a corresponding postage, and the postage can be the same for all mail pieces 111 that are in the same weight range. While it is expected that mail pieces 111 will usually be sorted before entering processing system 100 so that each piece is likely to be within the same weight range, embodiments of the invention can also be adapted for use with unsorted mail pieces 111. Often, mail pieces 111 carry the same contents and packaging as is the case for a mass mailing promotion.

In the context of the invention, applying postage to the mail piece may include: printing postage indicia on the mail piece, printing postage indicia on an item that can be affixed to or associated with the mail piece, charging the postage for the mail piece to a postage account, or some other technique for accounting for the postage for the mail piece. Applying postage to the mail piece does not necessarily require placing a physical postage indicia directly on the mail piece itself.

Mail piece processing system 100 first uses a calibration phase where a first set of mail pieces 111 are individually weighed to determine when mail pieces 111 are consistently within the selected weight range. Mail piece processing system 100 then enters an operational phase where a second set of mail pieces 111 are not weighed, but receive the postage determined in the calibration phase. Advantageously, the ability to stop weighing mail pieces 111 significantly speeds up processing.

The use of the term “set” (i.e. first set, second set, etc.) to distinguish between groups of mail pieces does not require that a given set of mail pieces has a definite number of mail pieces or is a discreet group of mail pieces. A set of mail pieces may be a discreet number of mail pieces or a known group of mail pieces in some embodiments, but in other embodiments, a set of mail pieces have an indeterminate number or be a member of an indeterminate group.

Weight system 101 operates in response to instructions 112-115 from control system 103. In response to start transfer instruction 112, weight system 101 receives mail pieces 111 and transfers them to postage system 102. In response to start weigh instruction 113, weight system 101 individually weighs mail pieces 111 and indicates the weights in weight signal 116 to control system 103. Weight system 101 may use an in-line scale to weigh mail pieces 111. In response to stop weigh instruction 114, weight system 101 stops weighing mail pieces 111. In response to stop transfer instruction 115, weight system 101 stops receiving and transferring mail pieces 111.

Postage system 102 operates in response to instructions 117-119 from control system 103. In response to start transfer instruction 117, postage system 102 receives mail pieces 111 from weight system 101 and transfers mail pieces 111 from mail piece processing system 100. In response to postage instructions 118, postage system 101 individually applies postage to mail pieces 111. Postage instructions 118 may comprise a standing instruction, an instruction for each phase, an instruction for each mail piece, or some combination. The postage may comprise a monetary amount or class of service. In response to stop transfer instruction 119, postage system 102 stops receiving and transferring mail pieces 111.

Control system 103 operates in response to instructions 120-122 from an operator or an external system. Weight range instruction 120 indicates a selected weight range or an instruction to select a weight range. Control system 103 transfers start transfer instructions 112 and 117 in response to start transfer instruction 121. For the calibration phase, control system 103 also transfers start weigh instruction 113 in response to start transfer instruction 121. Control system 103 transfers stop transfer instructions 115 and 119 in response to stop transfer instruction 122.

During the calibration phase, control system 103 receives weight signal 116 from weight system 101, processes weight signal 116 to select the postage, and transfers corresponding postage instructions 118 to postage system 102. Based on weight range instruction 120, control system 103 may also select the weight range based on weight signal 116. When control system 103 determines that weights from weight signal 116 are within the selected weight range on a consistent basis, control system 103 transfers stop weigh instruction 114 to weight system 101 causing system 100 to enter the operational phase. Advantageously, system 100 operation should speed up appreciably because there is no longer a need to wait for the weighing process—often the slowest process in system 100. During the operational phase, system 100 continues to receive, apply postage, and transfer mail pieces 111. The postage used for the second set of mail pieces 111 is the same as the postage determined in the calibration phase.

Thus, the first set of mail pieces 111 is processed during the calibration phase, and the second set of mail pieces 111 is processed during the operational phase. The transition from the calibration phase to the operational phase is triggered by a determination that weights from weight signal 116 are consistently within the selected weight range. This determination may be based on various factors. For example, the average weight of the first set of mail pieces may be calculated and compared to the weight range. If the average weight is within the weight range, then the calibration phase ends and the operational phase begins, but if the average weight exceeds the weight range, then an alarm is generated. Alternatively, each mail piece in the first set may be individually compared to the weight range. If the individual weights are each within the weight range, then the calibration phase ends and the operational phase begins, but if an individual weight exceeds the weight range, then an alarm is generated. The calibration phase may last for a set number of mail pieces or a set time period. The variance of the weights may be used to lengthen or shorten the calibration phase. For example, if the first set of mail pieces 111 is consistently the same weight to some mathematical degree, then the calibration process may be shortened. If some variance in weights is experienced, then the calibration phase may be extended to obtain additional confidence that the mail pieces consistently remain within the selected weight range. In addition, control system 103 could generate and transfer an alarm if weights for a number of the first set of mail pieces fall below the selected weight range.

It may be desirable to implement recalibration phases to check if the postage and selected weight range still correspond to mail pieces 111. To enter a recalibration phase for a third set of mail pieces, control system 103 transfers start weigh instruction 113 to weight system 101. During the re-calibration phase, control system 103 receives weight signal 116 from weight system 101 and processes weight signal 116 to verify that weights are within the selected weight range on a consistent basis. During re-calibration, individual postage instructions 118 may resume or a standing postage instruction 118 may be desirable. When the re-calibration phase is complete, control system 103 transfers stop weigh instruction 114 to weight system 101 to re-enter the operational phase for a fourth set of mail pieces 111.

Control system 103 may automatically enter recalibration phases after a set number of mail pieces 111 are processed in an operational phase, after a set time period of operational phase processing, or based on some other factors. During calibration or recalibration, control system 103 transfers alarm signal 123 if the weights from weight signal 116 are not within the selected weight range.

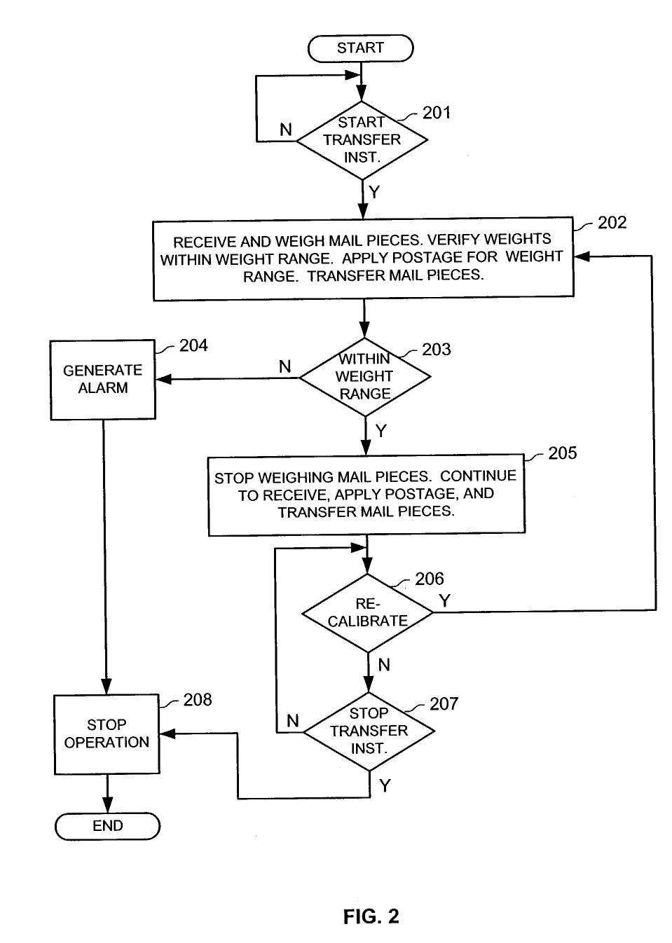

FIG. 2 illustrates the operation of mail piece processing system 100 in an example of the invention. Reference numbers from FIG. 2 are indicated parenthetically below. Operation starts when a start transfer instruction is received (201). If a start transfer instruction is received, then system 100 receives and weighs the mail pieces, verifies that the mail pieces are within the selected weight range, applies postage for the selected weight range to the mail pieces, and transfers the mail pieces (202). If the mail pieces are not consistently within the selected weight range (203), then system 100 generates an alarm (204) and stops operation (208). Alternatively, system 100 could generate an alarm and continue to operate in a calibration mode.

If the mail pieces are consistently within the selected weight range (203), then system 100 stops weighing the mail pieces, but continues to receive, apply postage to, and transfer the mail pieces (205). System 100 continues this operation until recalibration is required (206) or a stop transfer instruction is received (207). If recalibration is required (206), then system 100 proceeds to process 202. If a stop transfer instruction is received (207), system 100 stops operation (208).

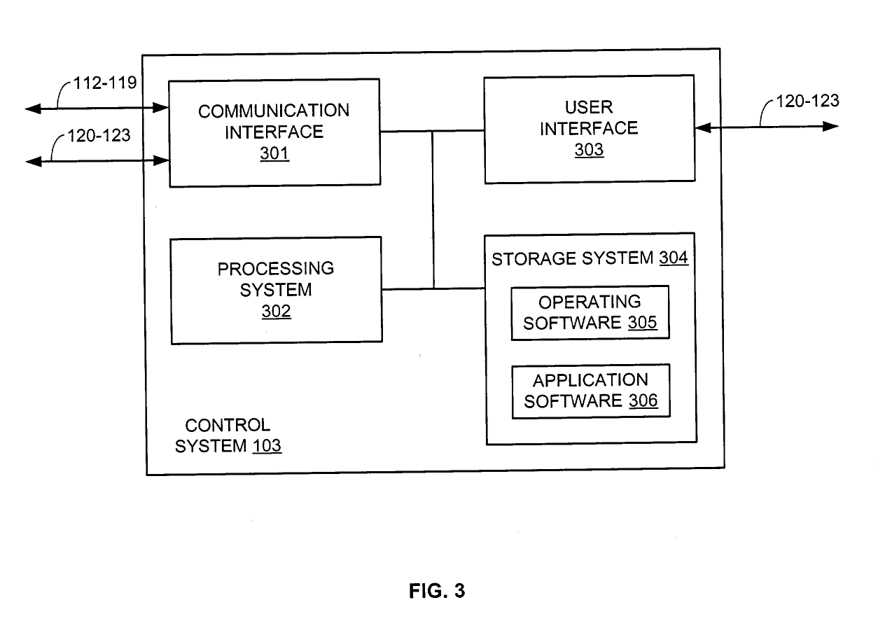

FIG. 3 illustrates control system 103 in an example of the invention. Control system 103 includes communication interface 301, processing system 302, user interface 303, and storage system 304. Storage system 304 stores operating software 305 and application software 306. Processing system 302 is linked to communication interface 301, user interface 303, and storage system 304. Control system 103 could be comprised of a programmed general-purpose computer, although those skilled in the art will appreciate that programmable or special purpose circuitry and equipment may be used. Control system 103 may use a client server architecture where operations are distributed among a server system and client devices that together comprise elements 301-306.

Communication interface 301 could comprise a network interface card, modem, port, or some other communication device. Communication interface 301 may be distributed among multiple communication devices. Processing system 302 could comprise a computer microprocessor, logic circuit, or some other processing device. Processing system 302 may be distributed among multiple processing devices. User interface 303 could comprise a keyboard, mouse, voice recognition interface, microphone and speakers, graphical display, touch screen, or some other type of user device. Storage system 304 could comprise a disk, tape, integrated circuit, server, or some other memory device. Storage system 304 may be distributed among multiple memory devices.

Processing system 302 receives and transfers instructions/signals 112-119 through communication interface 301. Processing system 302 receives and transfers instructions/signals 120-123 through communication interface 301 or through user interface 303. Processing system 302 retrieves and executes operating software 305 and application software 306 from storage system 304. Operating software 105 may comprise an operating system, utilities, drivers, networking software, and other software typically loaded onto a general-purpose computer. Application software 306 could comprise an application program, firmware, or some other form of machine-readable processing instructions. When executed by processing system 302, application software 306 directs processing system 302 to operate as described above for control system 103.

1. A method of processing mail pieces comprising:
weighing first mail pieces;
determining if the first mail pieces are within a weight range;
if the first mail pieces are within the weight range, applying postage that corresponds to the weight range to the first mail pieces; and
if the first mail pieces are within the weight range, applying the postage to second mail pieces without weighing the second mail pieces.

2. The method of claim 1 wherein weighing the first mail pieces comprises individually weighing the first mail pieces.

3. The method of claim 1 wherein determining if the first mail pieces are within the weight range comprises determining if individual weights of a desired number of the first mail pieces are within the weight range.

4. The method of claim 1 wherein determining if the first mail pieces are within the weight range comprises selecting the weight range.

5. The method of claim 1 further comprising, if the first mail pieces are not within the weight range, generating a signal indicating that the first mail pieces are not within the weight range.

6. The method of claim 1 further comprising:
weighing third mail pieces to determine if the third mail pieces are within the weight range;
if the third mail pieces are within the weight range, applying the postage to the third mail pieces; and
if the third mail pieces are within the weight range, applying the postage to fourth mail pieces without weighing the fourth mail pieces.

7. The method of claim 6 wherein weighing the third mail pieces comprises starting to weigh the third mail pieces after a set time period of processing the second mail pieces.

8. The method of claim 6 wherein weighing the third mail pieces comprises starting to weigh the third mail pieces after processing a set number of the second mail pieces.

9. The method of claim 6 further comprising, if the third mail pieces are not within the weight range, generating a signal indicating that the third mail pieces are not within the weight range.

10. A mail piece processing system comprising:
a weight system configured to weigh and transfer first mail pieces, and in response to a stop weigh instruction, to transfer second mail pieces without weighing the second mail pieces;
a postage system configured to apply postage that corresponds to a weight range to the mail pieces in response to postage instructions; and
a control system configured to transfer the postage instructions, determine if the first mail pieces are within the weight range, and if the first mail pieces are within the weight range, to transfer the stop weigh instruction.

11. The mail piece processing system of claim 10 wherein the weight system is configured to individually weigh the mail pieces.

12. The mail piece processing system of claim 10 wherein the control system is configured to determine if individual weights of a desired number of the first mail pieces are within the weight range.

13. The mail piece processing system of claim 10 wherein the control system is configured to select the weight range.

14. The mail piece processing system of claim 10 wherein the control system is configured to generate a signal indicating that the first mail pieces are not within the weight range.

15. The mail piece processing system of claim 10 wherein:
the weight system is configured to weigh and transfer third mail pieces in response to a start weigh instruction, and in response to a second stop weigh instruction, to transfer fourth mail pieces without weighing the fourth mail pieces; and
the control system is configured to transfer the start weigh instruction, determine if the third mail pieces are within the weight range, and if the third mail pieces are within the weight range, to transfer the second stop weigh instruction.

16. The mail piece processing system of claim 15 wherein control system is configured to transfer the start weigh instruction after a set time period of processing the second mail pieces.

17. The mail piece processing system of claim 15 wherein control system is configured to transfer the start weigh instruction after processing a set number of the second mail pieces.

18. The mail piece processing system of claim 15 wherein the control system is configured to generate a signal indicating that the third mail pieces are not within the weight range.

19. A processor readable medium having instructions thereon for:
weighing first mail pieces;
determining if the first mail pieces are within a weight range;
if the first mail pieces are within the weight range, applying postage that corresponds to the weight range to the first mail pieces; and
if the first mail pieces are within the weight range, applying the postage to second mail pieces without weighing the second mail pieces.

20. The processor readable medium of claim 19 having the instructions thereon for individually weighing the first mail pieces.

21. The processor readable medium of claim 19 having the instructions thereon for determining if individual weights of a desired number of the first mail pieces are within the weight range.

22. The processor readable medium of claim 19 having the instructions thereon for selecting the weight range.

23. The processor readable medium of claim 19 having the instructions thereon for, if the first mail pieces are not within the weight range, generating a signal indicating that the first mail pieces are not within the weight range.

24. The processor readable medium of claim 19 having the instructions thereon for:
weighing third mail pieces to determine if the third mail pieces are within the weight range;
if the third mail pieces are within the weight range, applying the postage to the third mail pieces; and
if the third mail pieces are within the weight range, applying the postage to fourth mail pieces without weighing the fourth mail pieces.

25. The processor readable medium of claim 24 having the instructions thereon for starting to weigh the third mail pieces after a set time period of processing the second mail pieces.

26. The processor readable medium of claim 24 having the instructions thereon for starting to weigh the third mail pieces after processing a set number of the second mail pieces.

27. The processor readable medium of claim 24 having the instructions thereon for, if the third mail pieces are not within the weight range, generating a signal indicating that the third mail pieces are not within the weight range.

28. A computer program product for a control system in a mail piece processing system comprising a weight system configured to weigh and transfer first mail pieces, and in response to a stop weigh instruction, to transfer second mail pieces without weighing the second mail pieces, and comprising a postage system configured to apply postage that corresponds to a weight range to the mail pieces in response to postage instructions, the computer program product comprising:
application programming configured to direct the control system to transfer the postage instructions, determine if the first mail pieces are within the weight range, and if the first mail pieces are within the weight range, to transfer the stop weigh instruction, and if the first mail pieces are not within the weight range, to generate an alarm signal; and
a storage system that stores the application programming.

29. The computer program product of claim 28 wherein the weight system is configured to weigh and transfer third mail pieces in response to a start weigh instruction, and in response to a second stop weigh instruction, to transfer fourth mail pieces without weighing the fourth mail pieces, and wherein the application programming is configured to direct the control system to transfer the start weigh instruction, determine if the third mail pieces are within the weight range, and if the third mail pieces are within the weight range, to transfer the second stop weigh instruction, and if the third mail pieces are not within the weight range, to generate the alarm signal.
